(19) United States
(12) Patent Application Publication
(10) Pub. No.: US 2022/0262333 A1
(43) Pub. Date: Aug. 18, 2022

(54) MODULAR GUITAR WITH TOOL-FREE INTERCHANGEABLE PICKUP

(71) Applicants: William H. Edwards, Tampa, FL (US); William H. Edwards, Tampa, FL (US)

(72) Inventors: William H. Edwards, Tampa, FL (US); William H. Edwards, Tampa, FL (US)

(21) Appl. No.: 17/672,640

(22) Filed: Feb. 15, 2022

Related U.S. Application Data
(60) Provisional application No. 63/150,058, filed on Feb. 16, 2021.

(51) Int. Cl. G10H 3/18; G10D 1/08; G10D 3/095

(52) U.S. Cl. CPC G10H 3/181; G10H 2220/461; G10D 3/095; G10D 1/085

(57) ABSTRACT

A modular electric guitar system is disclosed that includes tool-free interchangeable body components, including tool-free sides of a guitar body which may alter the instrument's overall shape, and tool-free interchangeable pickup cartridges to provide a dynamic range of instrument shape, size, and sound.

### CROSS-REFERENCE TO RELATED APPLICATIONS

The present application claims benefit under 35 U.S.C. Sec. 119 to U.S. provisional patent application Ser. No. 63/150,058 filed Feb. 16, 2021. The foregoing application is hereby incorporated by reference into the present application in its entirety.

### BACKGROUND OF THE DISCLOSURE

The present disclosure generally relates to stringed musical instruments, and more specifically to a modular guitar kit and devices for rapid, tool-free removal and insertion of instrument parts, including body components and pickups.

While certain aspects of conventional technologies have been discussed to facilitate disclosure, Applicant in no way disclaims these technical aspects, and it is contemplated that the claimed disclosure may encompass one or more of the conventional technical aspects discussed herein.

In this specification where a document, act, or item of knowledge is referred to or discussed, that reference or discussion is not an admission that the document, act, or item of knowledge or any combination thereof was at the priority date, publicly available, known to the public, part of common general knowledge, or otherwise constitutes prior art under the applicable statutory provision; or is known to be relevant to an attempt to solve any problem with which this specification is concerned.

### BRIEF SUMMARY OF THE DISCLOSURE

The present disclosure provides for tool-free removal of electric string instrument a pickup and insertion of a pickup. The disclosure also provides for tool-free removal and attachment of body components, including sides, or wings, of a guitar. Devices, kits, and methods are disclosed.

The following presents a simplified summary of the disclosure in order to provide a basic understanding of some aspects of the disclosure. This summary is not an extensive overview of the disclosure. It is intended neither to identify key or critical elements of the disclosure nor to delineate the scope of the disclosure. Its sole purpose is to present some concepts of the disclosure, in accordance with the disclosure, in a simplified form as a prelude to the more detailed description presented later.

In some embodiments, a modular guitar, kit, and system are disclosed. A further embodiment is an electric pickup cartridge. Methods related to these devices are also disclosed.

Embodiments of the present disclosure may include components manufactured from various materials based upon the contemplated use. Materials that are durable compared to the other structure or materials encountered by that material may include varying degrees of hardness whether superficial plating or the entire component's hardness are contemplated to be within the scope of the present disclosure. By way of example and not limitation, materials may be 6061 aluminum, 7075 aluminum, 1018 steel, brass, 303 stainless steel, and chromium and other platings thereon. Other components contemplated by the present disclosure include wood and plastics.

The present disclosure may address one or more of the problems and deficiencies of the prior art discussed above. However, it is contemplated that the disclosure may prove useful in addressing other problems and deficiencies in a number of technical areas. Therefore the claimed disclosure should not necessarily be construed as limited to addressing any of the particular problems or deficiencies discussed herein.

The following description and the annexed drawings set forth certain illustrative aspects of the disclosure. These aspects are indicative of only some of the various ways in which the principles of the disclosure may be employed, and the present disclosure is intended to include all such aspects and their equivalents. Other advantages and novel features of the disclosure will become apparent from the following description when considered in conjunction with the drawings.

### BRIEF DESCRIPTION OF THE DRAWINGS

The disclosure can be readily understood by considering the following detailed description in conjunction with the accompanying drawings, in which:

FIG. 1 illustrates a perspective view of an embodiment of the present disclosure encompassing a modular guitar.

FIG. 2 illustrates a perspective view of a modular guitar with wings detached.

FIG. 3 illustrates a perspective view of a set of two guitar wings.

FIG. 4 illustrates a perspective view of the wings of FIG. 3 attached to a modular guitar main body having pickup cartridges and traditional bridge and saddles.

FIG. 5 illustrates a perspective view of one guitar wing.

FIG. 6 illustrates a ghosted perspective view of the female locking mechanism.

FIG. 7 illustrates a perspective view of the female locking stud and spring, while FIG. 8 illustrates a side profile view of the male locking mechanism.

FIG. 9 illustrates a ghosted perspective view of a lock pin retainer and lock slot.

FIG. 10 illustrates a side perspective view of the female locking mechanism engaging a lock pin retainer under spring tension.

FIG. 11 illustrates a perspective view of the male locking mechanism.

FIG. 12 illustrates a bottom perspective view of the main body of a modular guitar.

FIG. 13 illustrates a top perspective view of the main body of a modular guitar with tremolo cavity exposed.

FIGS. 14 and 15 illustrate a top and bottom perspective views of the main body of a modular guitar with empty pickup cartridge cavities.

FIG. 16 illustrates a top perspective view of a pickup cartridge.

FIG. 17 illustrates a top view of a pickup cartridge.

FIG. 18 illustrates a perspective view of an embodiment of the pickup cartridge base with height adjustment features and electrical contacts.

FIG. 19 illustrates a side view of an electrical contact.

FIG. 20 illustrates a side perspective view of an electrical contact.

FIG. 21 illustrates a side perspective view of another embodiment of a modular guitar electrical contact.

### DETAILED DESCRIPTION

The following detailed description and the appended drawings describe and illustrate various embodiments of the disclosure solely for the purpose of enabling one of ordinary skill in the relevant art to make and use the disclosure. As such, the detailed description and illustration of these embodiments are purely exemplary in nature and are in no way intended to limit the scope of the disclosure, or its protection, in any manner. It should also be understood that the drawings are not to scale and in certain instances details have been omitted, which are not necessary for an understanding of the present disclosure, such as conventional details of fabrication and assembly.

In the Summary above, in the Description, and in the accompanying drawings, reference is made to particular features of the disclosure. It is to be understood that the disclosure in this specification includes all possible combinations of such particular features. For example, where a particular feature is disclosed in the context of a particular aspect or embodiment of the disclosure, or a particular claim, that feature can also be used, to the extent possible, in combination with and/or in the context of other particular aspects and embodiments of the disclosure, and in the disclosure generally.

The term “comprises” and grammatical equivalents thereof are used herein to mean that other components, structures, steps, etc. are optionally present. For example, an article “comprising” (or “which comprises”) components A, B, and C can consist of (i.e., contain only) components A, B, and C, or can contain not only components A, B, and C, but also one or more other components or structures.

Unless otherwise specified, the terms “approximately” and “about” when used in the context of a numeric figure are defined to mean±20% of a corresponding numeric value. The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

The term “mechanical features” is used herein to mean features of a component, mechanical or geometric, which have a functional purpose of attaching or linking that component to one or more other components with compatible or corresponding mechanical features. An example of a mechanical feature is a slot in a component, where said slot is designed to accept a tab from another component and the union of the slot and tab from the two components effectively links, attaches, fixes, and/or locks the components together. The term “mechanical features” refers to, but is not limited to: hooks, hook and loop fasteners, slot and tabs, all male and female fasteners, screws, bolts, nuts, holes that have been tapped, latches, pins, etc.

While the specification will conclude with claims defining the features of embodiments of the disclosure that are regarded as novel, it is believed that the disclosure will be better understood from a consideration of the following description in conjunction with the figures, in which like reference numerals are carried forward.

One embodiment of a modular string instrument comprises a main body and two or more wings. The main body has a head, a neck, and a central portion, the central portion has two body mating faces and each body mating face has one or more body locks. Each wing has a wing mating face and one or more wing locks, each wing mating face corresponds to the body mating face on the central portion, while each wing lock corresponds to the body lock of the central portion such that the two or more wings reversibly couple with the central portion through the combination wing and body locks in tool-free fashion.

In some embodiments, the modular string instrument includes a pickup cartridge receiving portion.

In some embodiments, a body lock comprises one or more slots dimensioned to accept the wing lock, a spring, and a lock pin, the lock pin being slidably constrained within the central portion under force of the spring and configured to couple with a wing lock through the one or more slots. In still other embodiments, the lock pin substantially comprises a cylinder having a button end, two locking portions, two release portions, and a spring seating portion. The wing lock may further comprise a locking tab, the locking tab having a tab aperture dimensioned to slidingly mate with the locking portion of the lock pin.

In another embodiment, a body wing is disclosed adapted to reversibly couple with a side of a main body of a stringed instrument, and which may include a male wing lock, or a female wing lock. The wing may also include an electrical contact. The male or female locks correspond to locking features on the main body, and electrical contacts correspond to electrical contact features on a main body.

Another embodiment of the present disclosure includes a coupling mechanism comprising a spring, a lock pin with a button end, a spring seating portion opposite to the button end, and two locking portions and two release portions in between, and a locking tab set that has two or more tabs. Each tab has an aperture dimensioned to slidingly mate with one of the locking portions of the lock pin. In some embodiments of a coupling mechanism, the lock pin locking portions further include a pin tapered portion, such that the locking tab set, as it operatively engages the pin tapered portion of the lock pin, slides the lock pin axially against the spring until the locking tab reaches a fully inserted locked position and the lock pin locking portions slide into the corresponding lock tab apertures.

In still yet another embodiment, a pickup cartridge is disclosed. A pickup cartridge includes a pickup base, a pickup coil attached to the pickup base, a cartridge body dimensioned to hold the pickup coil, and an electrical contact on an exterior surface of the cartridge body. In some embodiments, the pickup coil may be adjusted with height adjusters. The height adjusters may comprise an adjuster base coupled to the cartridge body and an adjuster post coupled to the pickup base. The adjuster base may comprise an internally-threaded portion, while the adjuster post may comprise an externally threaded portion dimensioned to threadingly engage the internally-threaded portion of the adjuster base. The pickup cartridge may comprise a system in which a stringed instrument has a pickup cartridge receiving portion and a pickup cartridge. In such a system, the pickup cartridge receiving portion of the stringed instrument is adapted to reversibly couple with the pickup cartridge both mechanically and electrically.

In still yet other embodiments, a modular string instrument kit is disclosed comprising a main body adapted to reversibly couple with two body wings and adapted to reversibly couple with a pickup cartridge, plus two body wings and a pickup cartridge, the wings and cartridge adapted to reversibly couple with the main body. The pickup cartridge may be adapted to provide electric communication between the pickup coil contained in the cartridge and receiving portion inside the pickup cartridge of the main body. In other embodiments, the pickup cartridge may be adapted to communicate directly with an amplifier.

A method of changing the shape of the body of a string instrument is also disclosed comprising the steps of providing a main body with a wing attachment area, providing a first body wing, coupling the first body wing to the main body, providing a second body wing, decoupling the first body wing from the main body, and coupling the second body wing to the main body. In this way, the shape of the guitar defined by the main body and first body wing is different from the shape of the guitar defined by the main body and the second body wing.

In yet further embodiments, methods of interchanging a pickup coil in an electric string instrument are disclosed. A method of coupling a pickup coil to an electric guitar comprises the steps of providing a stringed instrument body having a cavity with an opening positioned in an area below where a string passes over the front instrument body, the cavity adapted to slidingly accept a pickup cartridge from the back side of the instrument body and mechanically and electrically couple with a pickup cartridge, providing a cartridge having a pickup and adapted to couple with the instrument body cavity mechanically and electrically, and coupling the pickup cartridge to the instrument body by inserting the pickup cartridge into the cavity from the back side of the instrument body. Another embodiment includes a method of rapidly changing a pickup coil, the method comprising the steps of providing a stringed instrument body with a cavity positioned in an area close to where a string passes over the instrument body, the cavity adapted to slidingly accept a pickup cartridge and mechanically and electrically couple with a pickup cartridge, providing a first pickup cartridge having a pickup and adapted to couple with the instrument body cavity mechanically and electrically, inserting the first pickup cartridge into the cavity, removing the first pickup cartridge from the cavity, providing a second pickup cartridge adapted to couple with the instrument body cavity mechanically and electrically, and inserting the second pickup cartridge into the cavity.

In the present disclosure, several aspects of the modular guitar system are discussed at a sub-assembly level. Multiple aspects of the present disclosure may be implemented apart from the modular instrument, such as retrofitting existing instruments with components or assemblies disclosed herein. The disclosure is not limited to the components existing only as part of a modular guitar system, but may be independent of such a system.

One aspect of the present disclosure includes a pickup cartridge. The pickup cartridge may be inserted into and removed from the main instrument body, thus providing for rapid interchange of pickups from the instrument.

The pickup cartridge has a cartridge body into which one or more pickups are mounted. The cartridge body is dimension to correspond to a cartridge cavity on the main body of the instrument such that the cartridge may be inserted into, and operatively constrained in relation to the main body. The pickup cartridge body and main body cartridge cavity need not mirror each other. For example, the pickup cartridge body may include protrusions to reduce surface area contact between the pickup cartridge body and the main body cartridge cavity. In one embodiment, three points of contact may be provided between the cartridge body and the main body cartridge cavity.

In still yet another embodiment, the pickup cartridge body may be a pickup cartridge frame, with point of contact to maintain its position within the main body cartridge cavity, and having a bottom plate to cover the pickup cartridge when inserted within the main body.

The pickup cartridge may contain a base plate onto which one or more pickup coils may be mounted. The base plate may include a height adjustment screw aperture adapted to allow free rotation of the adjustment screw through the aperture. In some embodiments, the base plate adjustment screw aperture may be offset from the plane defined by the base plate. However, in other embodiments, the pickup base plate need not have offset screw adjustment areas or apertures. As an alternative, the adjustment mechanism (such as a screw) may be within the same plane as the base plate, or above or below the plane defined by the base plate.

Each pickup coil mounted to baseplate may be electrically connected to spring-loaded contacts on the side of the pickup cartridge body. The electrical contacts may be provided by wire, or other electrically conductive material, such as through the base plate, and adjustment screw directly to the contact provided on the outside of the cartridge body.

The pickup coil height adjustment screw may also include a seating nut to constrain the head of the height adjustment screw in relation to the baseplate height adjustment aperture. In this way, the seating nut rotates together with the shaft of the height adjustment screw, thereby preventing translation of the seating nut on the screw, and maintaining a constrained position of the adjustment aperture on the adjustment screw. The distal end of the adjustment screw threading the engages a base threaded portion, the base threaded portion constrained in relation to the cartridge body. As a consequence of the threaded engagement of the height adjustment screw with the threaded base portion, the relative height of the pickup baseplate changes in relation to the pickup body, and thus the relative height of the pickup coils is changed in relation to the instrument strings when the pickup cartridge is inserted into main body.

The pickup cartridge includes one or more electrical contacts. Electrical contacts may be spring-loaded. The contacts may be located on the surface of the pickup cartridge in any number of locations as may be desirable depending on the configuration of the cartridge and the main body. In one embodiment, the pickup cartridge includes two spring-loaded contacts on a side surface. In an alternative embodiment, electrical contacts may be provided at point of contact between the cartridge frame and the main body cartridge cavity.

The pickup cartridge may include a retention mechanism to retain the cartridge within the main body. Such retention mechanisms may include a rotating tab, self-locking mechanisms, detents, spring-loaded locking buttons, key-based locking mechanism, or other means of securing the pickup cartridge within the main body.

The main body includes a head, neck, and central portion. The head may include one or more tutors or tuning keys.

Together with the main body, the modular instrument may include one or more body wings. The main body, together with the one or more wings thereby defines a complete instrument body. Wings of different shapes, styles, designs, and other characteristics can be reversibly coupled to the main body, and thereby provide interchangeability between components having different desirable characteristics.

A wing may include adjustment control switches or dials, and communicate electrically or wirelessly with the main body or with a separate device. A wing may have a wire receiving portion on its side or surface adapted to accept a guitar amplifier cord. Alternatively or in addition to the wing-mounted wire receiver, the main body may have a wire receiving portion adapted to accept the guitar amplifier cord.

Magnets may be embedded in a wing, on the main body, or both to hold a pickup guard.

The main body and each wing includes one or more wing locks. A wing lock consists of a male lock and a female lock. In one embodiment, the main body includes the female locks while each wing includes corresponding male locks. Alternatively, the main body may include the male wing lock while the wings include the female wing lock. In one embodiment, each male lock consists of two tabs projecting outward from the component to which the male lock is attached. The tabs may be parallel to one another, or may have various configurations relative to one another. The outermost portion of the male locking tabs in this embodiment may include a tapered portion to facilitate insertion of the male portion into the corresponding female lock slots on the body or wing.

In one embodiment, a locking stud is provided which operatively interacts with and secures the male locking tabs within the female locking slots. The locking stud is retained within a cylindrical cavity of the main body by a lock pin. The locking stud may include one or more locking portions and one or more release portions, the release portion having a narrower diameter than the locking portion. The locking stud may be spring-loaded to maintain the locking stud in a locked position. The locking stud locking portion operatively interacts with the male tab locking aperture such that the male tab is retained within the female locking slot. In this way, the male lock tabs can be inserted into the female lock slots, the tapered front portion of the tabs engaging the locking stud to slide the stud and allowing full insertion of the male locking portion into the female locking portion. Upon fully seating the male locking tab, the lock stud then slides into the locked position, causing the stud lock portion to insert into the male tab lock aperture.

The locking stud and male locking tab aperture may also include a tapered portion on one or both components so as to facilitate tight mechanical lock between the locking stud and male locking tab aperture.

The locking stud need not be cylindrical, but may be angular such that the spring-loaded locking functionality achieving mechanical coupling between the female and male lock components is achieved.

The main body includes one or more pickup cartridge cavity.

Within the cartridge cavity are one or more electrical contacts adapted to provide electrical connection between the pickup cartridge and the main body. Electrical contacts may be spring-loaded, either on the main body or on the pickup cartridge. The contacts on the main body may be located on the surface of the pickup cartridge cavity in any number of locations as may be desirable depending on the configuration of the cartridge and the main body. In one embodiment, the main body pickup contacts include two contacts on a side surface within the pickup cartridge cavity. In an alternative embodiment, electrical contacts may be provided at point of contact between the cartridge frame and the main body cartridge cavity.

The main body may also include electrical contacts on a side of the main body at an interface with a wing. In such an embodiment, the wing may include electrical components, such as adjustment buttons or dials, or a cord receiving portion for connecting the instrument to an external amplifier.

The main body may also include a pickup bezel or escutcheon. The pickup bezel may also provide a positive stop for the pickup cartridge such that, when fully inserted, the pickup cartridge makes contact with the pickup bezel. Alternatively, the pickup bezel may cover the pickup, and thereby enclose the top portion of the cartridge cavity. A separate positive stop within the pickup cavity may be provided separate from the pickup bezel.

The main body may be configured to accept certain sets of wings. In this way, certain styles of wings may be interchangeably coupled with the main body, but not others. Different main body may be provided to reversibly coupled with its own set of wing designs. Wing sets may or may not be interchangeable between main body types.

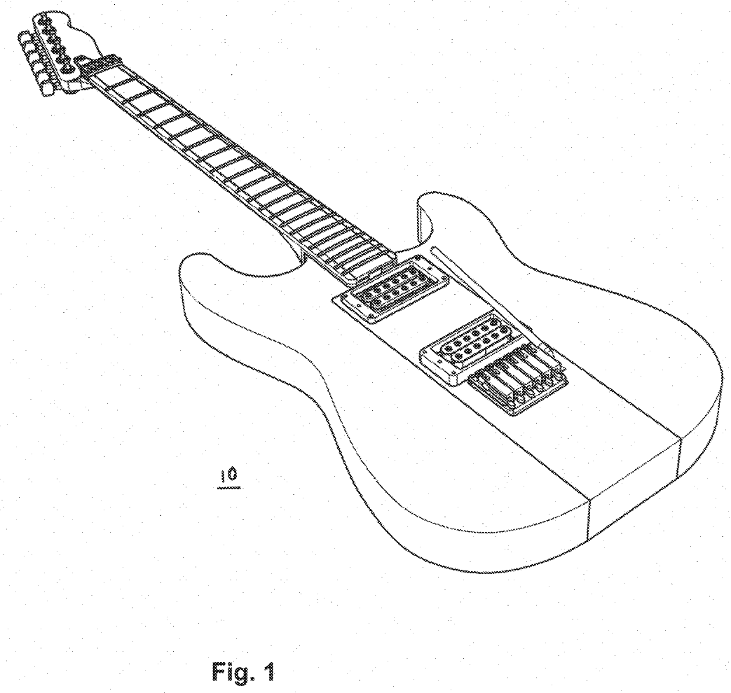

Now, with reference to FIG. 1, an embodiment of a modular guitar 10 is depicted with pickup cartridges, linear tremolo, and string lock.

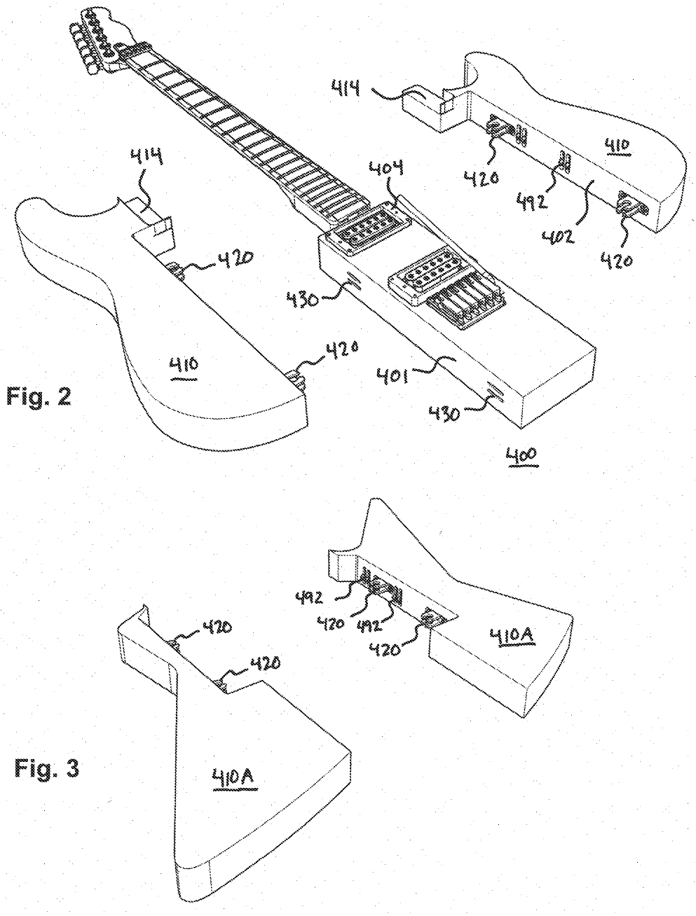

FIG. 2 illustrates a partially disassembled perspective view of an embodiment of a modular guitar. Wings 410 are shown apart from main body 400. Wings 410 each include neck support portions 414. Each wing is has four male locking tabs 420, while main body 400 includes eight locking slots 430, four on each side 401, with male locking tabs 424 corresponding to female locking slots 430 such that wings 410 reversibly couple with main body 400 and align wing sides 402 to main body sides 401.

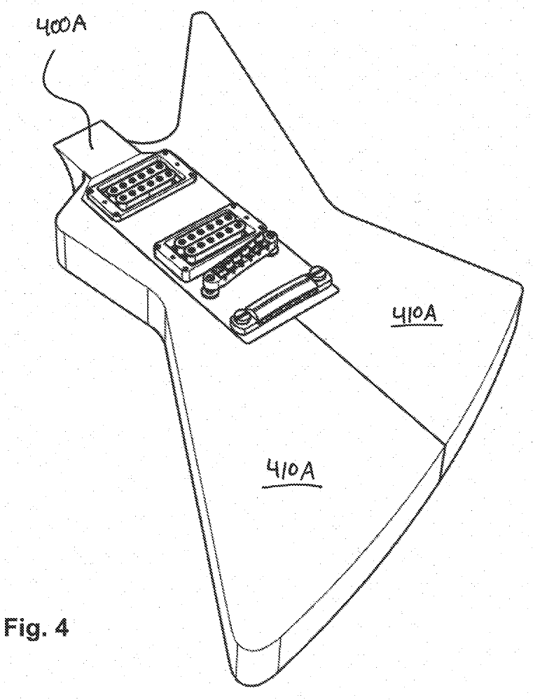

FIGS. 3 and 4 illustrate a set of differently shaped wings 410A, reversibly mateable with another embodiment of a main body 400A of a modular guitar.

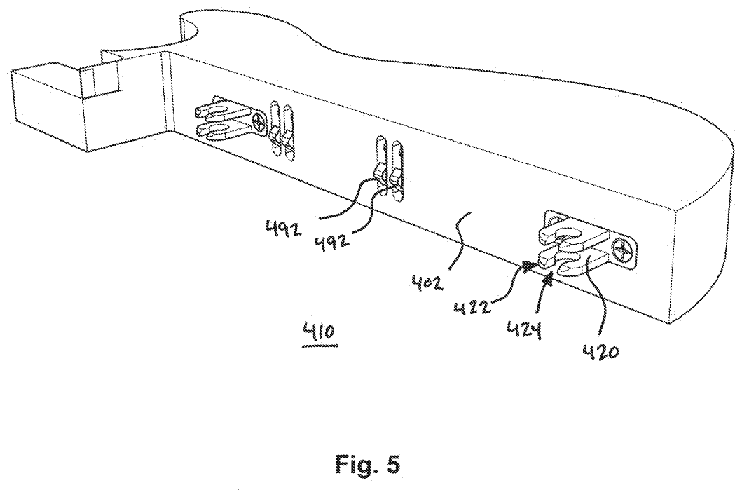

FIG. 5 illustrates a perspective view of a wing 410. On wing mating face 402, two pairs of male locking tabs 420 project outward from the wing mating face, and are distanced apart from one another to provide enhanced structural integrity and alignment with the main body. Each locking tab 420 includes tapered front portion 422 and locking aperture 424. Electrical contacts 492 are provided on the wing mating face 402, and aligned with corresponding electrical contacts on main body side 401 such that when wing 410 is mechanically coupled to main body 400, electrical contacts 492 make electrical contact with corresponding contacts on main body 400.

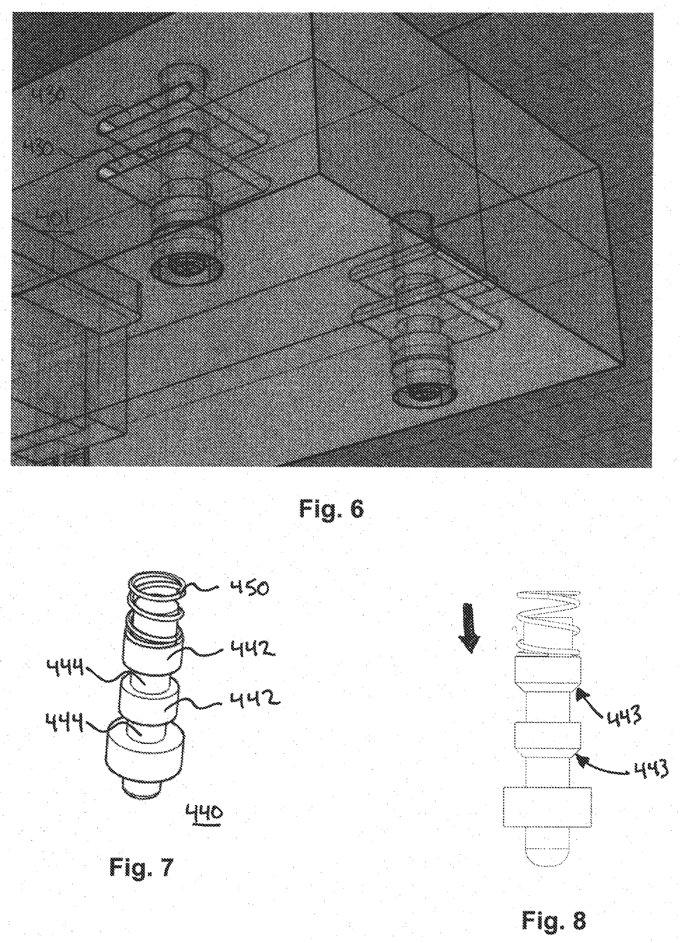

FIG. 6 illustrates a ghosted perspective view of the female locking mechanism contained within main body 400. Locking slots 430 are provided on each side 401, with the slots dimensioned to accept the corresponding male tab locking component. In this particular embodiment, locking slots 430 are paired in vertical orientation relative to a locking stud contained within main body 400.

FIGS. 7 and 8 illustrate locking stud 440, and having a pair of stud locking portions 442, and a pair of stud release portions 444. Stud spring 450 is provided coaxially with the central axis of stud 440, such that, when constrained within main body 400, the locking stud is retained under positive spring force such that locking portions 442 are aligned co-planar to locking slots 430. When spring 450 is compressed under force by a user, stud blocking portions 442 are pushed out of plane from the locking slots 430, while stud release portions 444 move into co-planar alignment with locking slots 430, thereby allowing release of the male locking tabs 420. Stud locking portions 442 may include a tapered portion 443 about their bottom circumference to facilitate insertion of male locking tabs 420 with their locking tab tapered portion 422 into female locking slots 430 by applying axial force to locking stud 440, and compressing lock spring 450 as male locking tabs 420 slide into a fully seated position, at which point the locking tab lock aperture comes into axial alignment with locking stud 440. Upon full insertion of the male tabs 420 into female locking slots 430, axial downward force applied by spring 450 slides locking stud 440 into a locked position, and thereby creating a mechanical couple between wing 410 and main body 400.

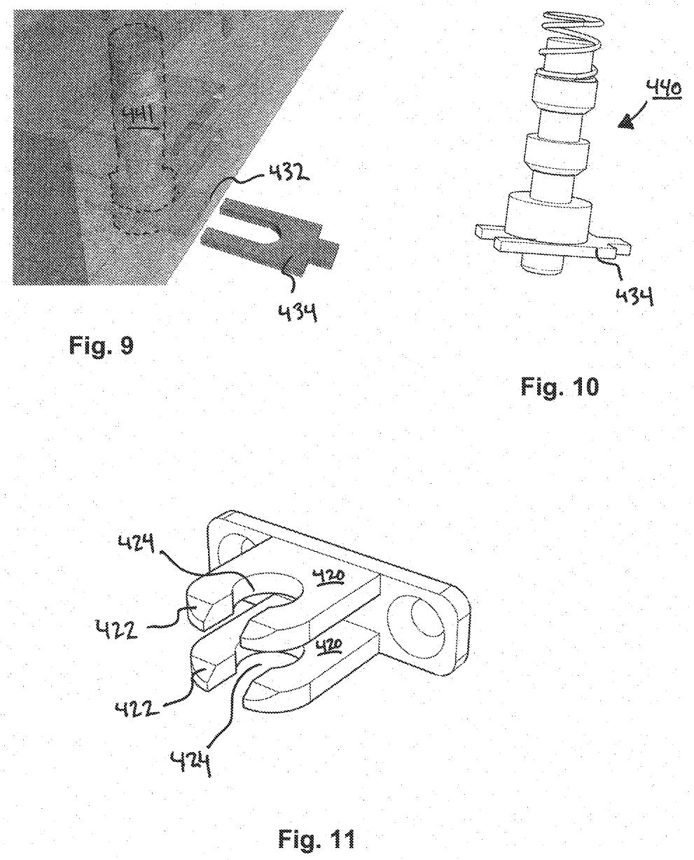

FIGS. 9 and 10 illustrate the lock pin or stud retainer 434 and stud retainer slot 432. The stud retainer 434 slides into stud retainer slot 432, and thereby retains the wing locking stud 440 within the cylindrical portion 441 of the main body, under spring tension.

FIG. 11 illustrates a perspective view of a male locking tab having a set of two locking tabs 420. In this embodiment, each locking tab includes a tapered portion 422 at the outermost portion of each tab so as to facilitate insertion of the tabs into the corresponding slots on the joining component and also enhance axial displacement of the locking stud. Locking tab lock apertures 424 are provided on each locking tab. The locking tab lock apertures include an open portion and a partial circular portion. Locking tabs 420 are provided parallel to each other.

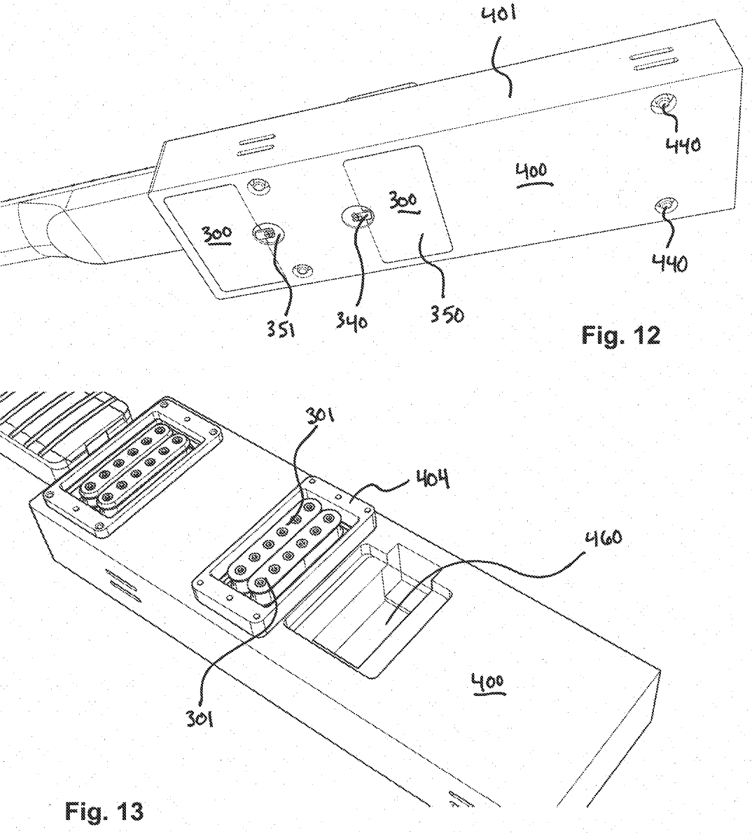

FIG. 12 shows a bottom perspective view of main body 400. Pickup cartridges 300 are shown fully inserted into main body 400, and retained therein through tabs 340. Tabs are provided on the bottom of main body 400 within a recessed area, each tab 340 rotatably affixed to main body 400 to provide retention of pickup cartridge 300. Each pickup cartridge 300 includes cartridge bottom 350, thus providing a continuous surface on the bottom of main body 400 when cartridges 300 are inserted. Pickup cartridge bottom 350 may further include a corresponding recessed portion to accept pickup lock tab 340 when in a locked position. Lock tab recessed portion 351 is provided within the main body in which pickup lock tab 340 may rotatably move from a locked position to an unlocked position, thus facilitating insertion and removal of pickup cartridge 300 from main body 400. Locking studs 440 are shown recessed within main body 400, with an accessible portion protruding in recessed fashion relative to the bottom of main body 400, and operable by a user.

FIG. 13 depicts a top perspective view of main body 400 with wings detached. Tremolo cavity 460 is shown without any tremolo assembly inserted. Pickup bezel 404 is shown mounted to the top surface of main body 400. When pickup cartridge 300 is inserted into main body 400, pickups 301 are then held in the desired playing position. In this way, multiple different pickups with varying types of pickups, numbers of pickups, and pickup heights are readily swapped within main body 400.

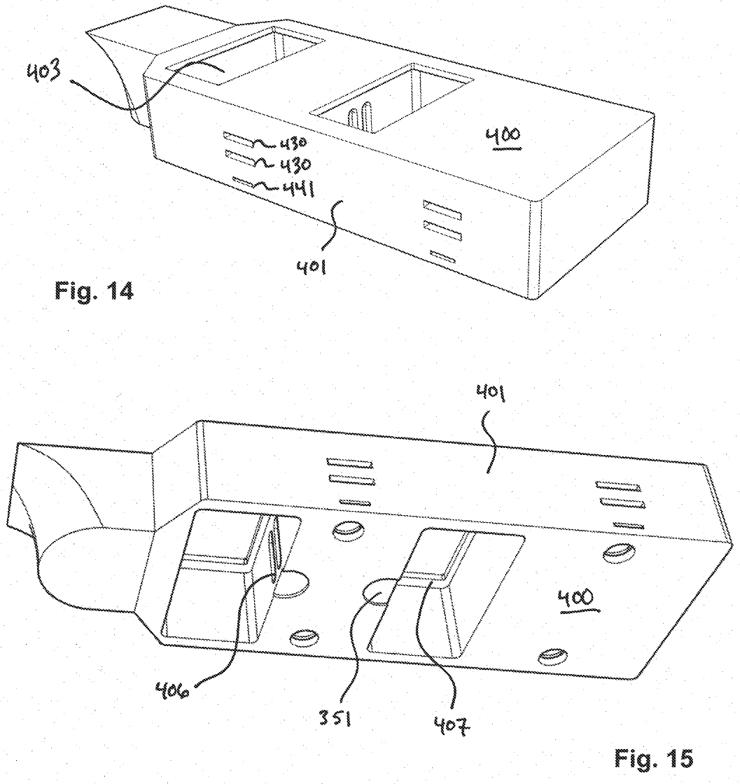

FIGS. 14 and 15 illustrate top and bottom perspective views of a portion of main body 400 with mating faces 401 and pickup cartridge cavities 403. On mating face 401 are locking slots 430. In this embodiment, a retention slot 441 may be provided to facilitate retention of a locking stud within the main body. Main body 400 includes recessed swivel locking tab portions 405 proximate to pickup cartridge cavities 403. At an upper portion on the top side of the instrument is a lip 407 functioning as a positive stop relative to the pickup cartridge. Electrical contacts 406 are provided within pickup cartridge cavity 403, and aligned to electronically mate with corresponding contacts on a pickup cartridge. Within the pickup cartridge cavity and as part of the main body is a cavity lip 407 providing for a positive stop of the pickup cartridge 300 when inserted into the pickup cartridge cavity. When fully inserted, a pickup cartridge is then both mechanically and electrically coupled to the main body.

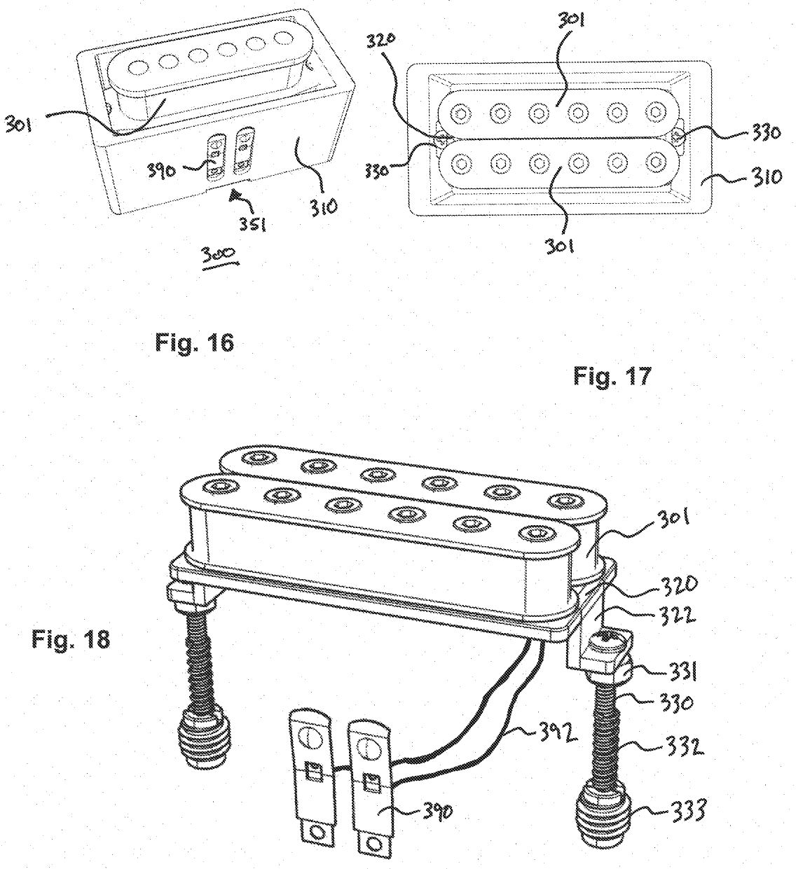

FIG. 16 illustrates an embodiment of a pickup cartridge 300. Pickup cartridge 300 includes a cartridge body 310, recessed electrical contacts 390, and a locking tab recessed portion 351. Depending on its depth setting within the cartridge, as provided for by height adjustment screws 330, pickup 301 may project upward from cartridge body 310 slightly. In this way, when pickup cartridge 300 is inserted into a pickup cavity on the main body, the pickup projects past the positive stop provided by the top portion of the pickup cavity and comes into an operative position relative to the strings on the instrument. Electrical contacts 390 may be recessed within cartridge body 310, while the corresponding electrical contacts within the pickup cartridge cavity may project out into the cartridge cavity slightly.

FIG. 17 shows a top view of pickup cartridge 300, showing height adjustment screws 330 offset from pickup base 320. A double coil pickup 301 is mounted to pickup plate 320.

FIG. 18 depicts an embodiment of the internal height adjustment components of pickup cartridge 300, together with electrical components. Coil pickups 301 are mounted on pickup plate 320. Offset portions 322 on either side of the pickup plate 320 provide separate mounting surfaces for height adjustment screws 330 and adjustment screw nuts 331. The distal end of adjustment screws 330 threadingly engage interior threads on adjustment screw bases 333, which in turn are threadingly mounted into the cartridge body by external threads on the screw base. Height adjustment springs 332 provide spring force between adjustment screw nuts 331 and adjustment screw bases 333. In operation, height adjustment screws 330 threadedly translate the height of pickup base 320 relative to the pickup body 310, and thus in turn adjust the relative height of the upper surface of the pickups 301. Electrical contacts 390 are in electrical communication with pickups 301 via wires 392 (the electrical contacts shown illustrated without the pickup body into which they are mounted).

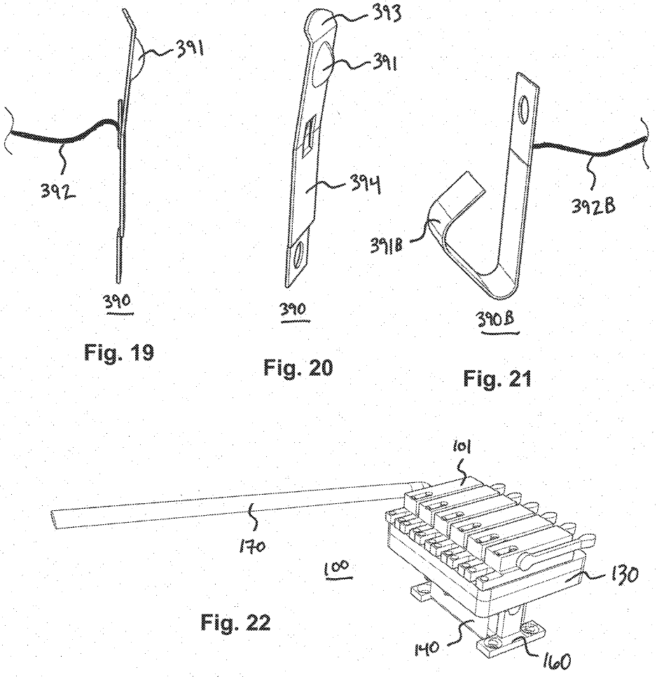

FIGS. 19 and 20 show closeup side and perspective views of cartridge electrical contacts 390. Convex contact point 391 is provided on the surface of contact 390, projected at an angle outward from attachment point 394. Top angled portion 393 projects rearwardly of convex contact point 391 to facilitate sliding insertion of the pickup cartridge into the main body.

FIG. 21 illustrates another embodiment of an electrical contact 390B, such as the contact contained within pickup cartridge cavity on the main body. In this embodiment, contact point 391 B is provided under spring tension outward from the base of the contact. In operation, contact 390 comes into electrical contact with and slides past contact 390B, reaching an inserted operative position as between the first component and the second component to which each of the respective contacts are mounted. Electrical contact 390B need not be used in conjunction with electrical contact 390, as each of the separate embodiments disclosed herein provide alternative means for providing electrical communication between two components slidingly made with respect to one another. A corresponding electrical contact may not have similar spring force, such as a static mounted flat contact.

As referenced in this disclosure and claims, “a string” is not to be construed as a structural limitation, but is instead descriptive of a component of the instrument or other components disclosed.

In light of the foregoing description, it should be recognized that embodiments in accordance with the present disclosure can be realized in numerous configurations contemplated to be within the scope and spirit of the claims. Additionally, the description above is intended by way of example only and is not intended to limit the present disclosure in any way, except as set forth in the claims.

In addition, though the disclosure has been described in reference to several examples optionally incorporating various features, the disclosure is not to be limited to that which is described or indicated as contemplated with respect to each variation of the disclosure. Various changes may be made to the disclosure described and equivalents (whether recited herein or not included for the sake of some brevity) may be substituted without departing from the true spirit and scope of the disclosure. In addition, where a range of values is provided, it is understood that every intervening value, between the upper and lower limit of that range and any other stated or intervening value in that stated range, is encompassed within the disclosure.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element-irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present disclosure is not to be limited to the examples provided and/or the subject specification, but rather only by the scope of claim language associated with this disclosure.

What is claimed:

1. A modular string instrument comprising:
a main body having a head, a neck, and a central portion, the central portion having two body mating faces and each body mating face having one or more body locks; and
two or more wings, each wing having a wing mating face and one or more wing locks, each wing mating face corresponding to the body mating face on the central portion, and each wing lock corresponding to the body lock of the central portion whereby the two or more wings reversibly couple with the central portion through the combination wing and body locks.

2. The modular string instrument of claim 1 wherein the central portion further comprises a pickup cartridge receiving portion.

3. The modular string instrument of claim 1 wherein the one or more body locks comprises one or more slots dimensioned to accept the wing lock, a spring, and a lock pin, the lock pin being slidably constrained within the central portion under force of the spring and configured to couple with a wing lock through the one or more slots.

4. The modular string instrument of claim 3 wherein the lock pin substantially comprises a cylinder having a button end, two locking portions, two release portions, and a spring seating portion.

5. The modular string instrument of claim 4 wherein the wing lock further comprises a locking tab, the locking tab having a tab aperture dimensioned to slidingly mate with the locking portion of the lock pin.

6. The modular string instrument of claim 4 wherein the locking tab further comprises a tab tapered portion, and the lock pin locking portions further comprises a pin tapered portion, wherein the locking tab, as it is inserted into the one or more slots operatively engages the pin tapered portion of the lock pin, sliding the lock pin within the central portion until the locking tab reaches a fully inserted locked position, and the lock pin locking portions slide into the lock tab aperture.

7. A body wing adapted to reversibly couple with a side of a main body of a stringed instrument.

8. The body wing of claim 7 further comprising a male wing lock.

9. The body wing of claim 7 further comprising a female wing lock.

10. The body wing of claim 7 further comprising an electrical contact corresponding to a mating electrical contact on a main body.

11. A coupling mechanism comprising:
a spring;
a lock pin having a button end, a spring seating portion distal to the button end, and two locking portions and two release portions situated therebetween; and
a locking tab set, the locking tab set having two or more tabs, each tab having an aperture dimensioned to slidingly mate with one of the locking portions of the lock pin.

12. The coupling mechanism of claim 11 wherein the lock pin locking portions further comprise a pin tapered portion, wherein the locking tab set, as it operatively engages the pin tapered portion of the lock pin, slides the lock pin axially against the spring until the locking tab reaches a fully inserted locked position and the lock pin locking portions slide into the corresponding lock tab apertures.

13. A pickup cartridge comprising:
a pickup base;
a pickup coil attached to the pickup base;
a cartridge body dimensioned to hold the pickup coil; and
an electrical contact mounted to an exterior of the cartridge body, the contact in electrically connected to the pickup coil.

14. The pickup cartridge of claim 13 further comprising one or more height adjusters.

15. The pickup cartridge of claim 14 wherein the one or more height adjusters comprises an adjuster base coupled to the cartridge body and an adjuster post coupled to the pickup base.

16. The pickup cartridge of claim 15 wherein the adjuster base comprises an internally threaded portion and the adjuster post comprises an externally threaded portion dimensioned to threadingly engage the internally threaded portion of the adjuster base.

17. A pickup cartridge system comprising:
an instrument having a pickup cartridge receiving portion; and
a pickup cartridge.

18. An instrument having a pickup cartridge receiving portion, the pickup cartridge receiving portion adapted to reversibly couple with a pickup cartridge both mechanically and electrically.

19. A modular string instrument kit, the kit comprising:
a main body adapted to reversibly couple with two body wings and to reversibly couple with one or more pickup cartridges;
one or more body wings adapted to reversibly couple with the main body; and
a pickup cartridge adapted to reversibly couple with the main body.

20. The modular string instrument kit of claim 22 wherein the pickup cartridge and main body are adapted to provide electric communication between one or more pickup coils contained in the pickup cartridge and the main body.

21. The modular string instrument kit of claim 22 wherein the pickup cartridge is adapted to communicate directly with an amplifier.

22. A method of changing the shape of the body of an electric guitar comprising the steps of:
providing a main body with a wing attachment area;
providing a first body wing;
coupling the first body wing to the main body;
providing a second body wing;
decoupling the first body wing from the main body; and
coupling the second body wing to the main body so as to make a complete guitar body with a shape different from the guitar with the first body wing attached to the main body.

23. A method of coupling a pickup coil to an electric guitar comprising the steps of:
providing a stringed instrument body having a cavity with an opening positioned in an area beneath where one or more strings pass over the instrument body face, the cavity adapted to slidingly accept a pickup cartridge from the back side of the instrument body and mechanically and electrically couple with a pickup cartridge;
providing a cartridge having a pickup and adapted to couple with the instrument body cavity mechanically and electrically; and
coupling the pickup cartridge to the instrument body by inserting the pickup cartridge into the cavity from the back side of the instrument body.

24. The method of claim 23 further comprising the steps of:
removing the cartridge from the body cavity;
providing a second pickup cartridge having a pickup and adapted to couple with the instrument body cavity mechanically and electrically; and
inserting the second pickup cartridge into the cavity.
